(19) United States
(12) Patent Application Publication
(10) Pub. No.: US 2007/0121778 A1
(43) Pub. Date: May 31, 2007

(54) Method and System For Spinal Cord Detection In Computed Tomography Volume Data

(75) Inventors: Hong Shen, Plainsboro, NJ (US); Andrew Litvin, Rocky Hill, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH INC, PRINCETON, NJ (US)

(21) Appl. No.: 11/539,273

(22) Filed: Oct. 6, 2006

Related U.S. Application Data
(60) Provisional application No. 60/727,571, filed on Oct. 17, 2005.

(51) Int. Cl. H05G 1/60

(52) U.S. Cl. 378/4

(57) ABSTRACT

A system and method for detecting the spinal cord in thoracic and abdominal computed tomography (CT) volume data is disclosed. In this method, an initial spinal cord point is detected for an initial axial slice of the CT volume data. The spinal cord is then tracked from the initial spinal cord point across each remaining axial slices in opposite directions from the initial axial slice by sequentially detecting a spinal cord point for each of the remaining axial slices The initial spinal cord point is detected using a ring model based on intensity differences in the initial axial slice. For each remaining axial slice, a spinal cord center position based on at least one previously detected spinal cord point. The spinal cord points on each of the remaining axial slices are detected based on intensity differences in the axial slice as well as proximity to the predicted spinal cord center position for the axial slice.

This application claims the benefit of U.S. Provisional Application No. 60/727,571 filed Oct. 17, 2005, the disclosure of which is herein incorporated by reference.

### BACKGROUND OF THE INVENTION

The present invention relates to detection of the spinal cord in thoracic and abdominal computed tomography (CT) volume data.

Computed tomography (CT) is a medical imaging method whereby digital geometry processing is used to generate a three-dimensional image of the internal anatomy of a patient from a large series of two-dimensional X-ray images taken around a single axis of rotation. Such CT imaging results in CT volume data which is a virtual representation of the internal anatomy of a patient. The CT volume data consists of multiple slices, or two-dimensional images, that can be combined to generate a three dimensional image. CT imaging is particularly useful because it can show several types of tissue including lung, bone, soft tissue and blood vessels, with great clarity. Accordingly, such imaging of the body can be used to diagnose problems such as cancers, cardiovascular disease, infectious disease, trauma and musculoskeletal disorders.

Bone is one of the most prominent anatomies in CT volume data and can therefore be reliably detected from such data. As represented in CT volume data, shapes of individual bone pieces are unique, thus allowing reliable discrimination between and identification of different bones. For example, vertebrae in the thoracic and abdominal regions can be valuable as features resources. That is, vertebrae can be used as a prominent feature for a reference point in CT volume data in order to compare or register multiple CT volume data sets. This is because vertebrae have complex structures and interfaces to provide distinctive features such as lines, planes, corners, circles, etc., which can be used to detect the vertebrae. Also, there are vertebrae throughout the chest and abdominal area and the vertebrae have similar but distinctive shapes that can be differentiated from one another. Furthermore, vertebrae move with turns and twists of the body, making the features relatively stable to body motion. Accordingly, vertebrae can be used as reference features for CT volume data used in the diagnosis of many different organs and body sections.

### BRIEF SUMMARY OF THE INVENTION

The present inventors have recognized that, in addition to detecting vertebrae in CT volume data, detecting the spinal cord as a prominent feature may be useful in a variety of applications. For example, in the diagnosis of various cancers, it is desirable to observe tumor growth over a period of time by comparing two CT scans taken for this purpose. In order to match the tumors in two sets of volume data from the same patient, rough registration is needed. In such a registration, the spinal cord can be used as a feature correspondence between the two data sets to estimate a geometrical transformation. While the transformation will not be deformable and hence, will be approximate, it is sufficiently accurate to compare the tumor correspondence.

The present inventors have also recognized that detection of the spinal cord in CT volume data can be used for various other applications, such as detecting and diagnosing disease in the spine and identifying whether two CT volume data sets are from the same patient.

Therefore, the present inventors have invented a method and apparatus for detection of the spinal cord in thoracic and abdominal CT volume data. In one embodiment of the present invention, an initial spinal cord point is detected for an initial axial slice of the CT volume data. The spinal cord is then tracked from the initial spinal cord point across each remaining axial slices in opposite directions from the initial axial slice by sequentially detecting a spinal cord point for each of the remaining axial slices. The initial spinal cord point is detected using a ring model based on intensity differences in the initial axial slice. This ring model determines a ring shaped spinal cord region based on average intensity differences at various distances from the center of the ring. The center point of the ring is determined to be the initial spinal cord point. For each remaining axial slice, a spinal cord center position based on at least one previously detected spinal cord point. For any axial slice, a line can be fit to K previous spinal cord points on K previously processed axial slices. The predicted spinal cord center position is the intersection point of this line and the axial slice. The spinal cord point on the axial slice is calculated by minimizing an energy function having a term representing the ring model intensity differences in the axial slice and a term representing the proximity to the predicted spinal cord center position.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary axial slice of a thoracic CT volume data set;

FIGS. 2A and 2B illustrate exemplary axial slices 210 and 220 of a thoracic CT volume data set having a closed contour and an open contour, respectively;

FIG. 3 illustrates a method of detecting the spinal cord in thoracic and abdominal CT volume data according to an embodiment of the present invention;

FIG. 4 illustrates a method for detecting an initial spinal cord point in an axial slice according to an embodiment of the present invention;

FIG. 5 illustrates a ring model;

FIG. 6 illustrates a method for detecting a spinal cord point in a current axial slice based on spinal cord points detected on previously processed axial slices and intensity variations of the current axial slice according to an embodiment of the present invention;

FIG. 7 illustrates exemplary spinal cord detection results using the above described method;

FIG. 8 illustrates an exemplary coronal slice of a thoracic CT volume data set showing a spinal cord centerline; and

FIG. 9 illustrates a high level block diagram of a computer capable of implementing the present invention.

### DETAILED DESCRIPTION OF EXEMPLARY EMBODIMENTS

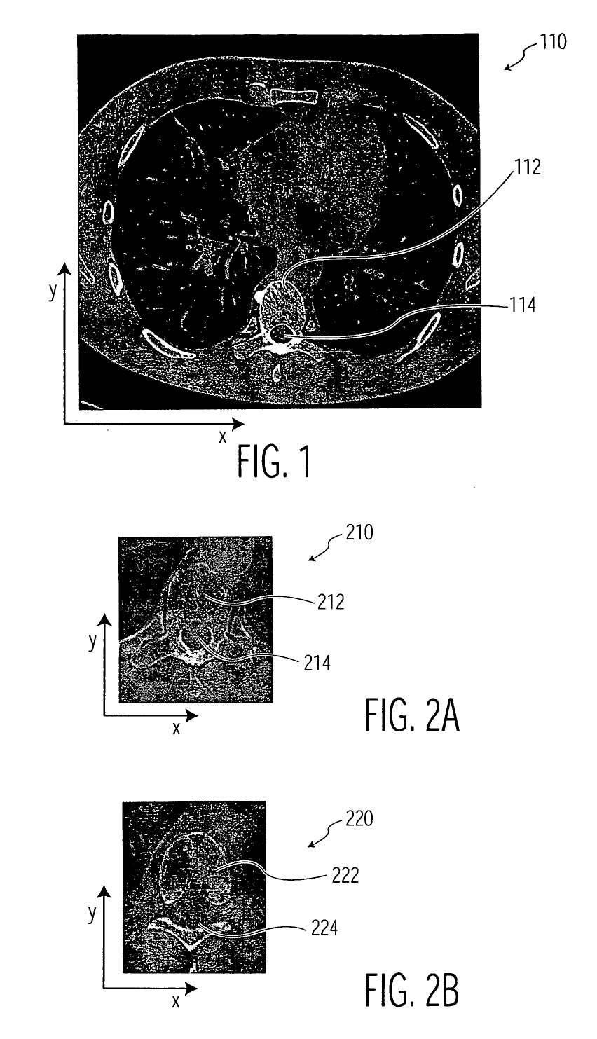

The present invention is directed to detecting the spinal cord in thoracic and abdominal CT volume data. This CT volume data is a virtual representation of a 3D CT image and can be manipulated by a computer system in order to perform the method of the present invention. A 3D coordinate system is defined herein as having a z-axis running from the top to bottom of the body, a y-axis running from the back to the front of the body, and an x-axis running from left to right across the body. The CT volume data consists of a plurality of axial slices, which are two-dimensional images along the x and y axes. Each axial slice corresponds to a separate z value. FIG. 1 illustrates an exemplary axial slice 110 of a thoracic CT volume data set. The axial slice 110 is a view generated along the axial plane, which is orthogonal to the long axis (z-axis) of the body. As illustrated in FIG. 1, a vertebra 112 and the spinal cord 114 can be seen in the axial slice 110.

According to an embodiment of the present invention, the spinal cord is detected in CT volume data by detecting a location of the spinal cord (in x, y coordinates) in one axial slice and tracking the spinal cord in the z direction across each of the plurality of axial slices. FIGS. 2A and 2B illustrate exemplary axial slices 210 and 220 of a thoracic CT volume data set having a closed contour and an open contour, respectively. As illustrated in FIG. 2A, the axial slice 210 shows a cross section of a vertebrae 212 with a spinal cord region 214 in the middle of the vertebrae 212. The axial slice 210 of FIG. 2A contains a closed contour, meaning that the spinal cord region 214 is completely surrounded by the bone of the vertebrae 212. This forms a ring-like spinal cord region 214, as illustrated in FIG. 2A. As illustrated in FIG. 2B, the axial slice 220 shows a cross section a vertebrae 222 with a spinal cord region 224 in the middle of the vertebrae 222. The axial slice 220 of FIG. 2B contains an open contour, meaning that the spinal cord region 224 is not fully surrounded by the bone of the vertebrae 222.

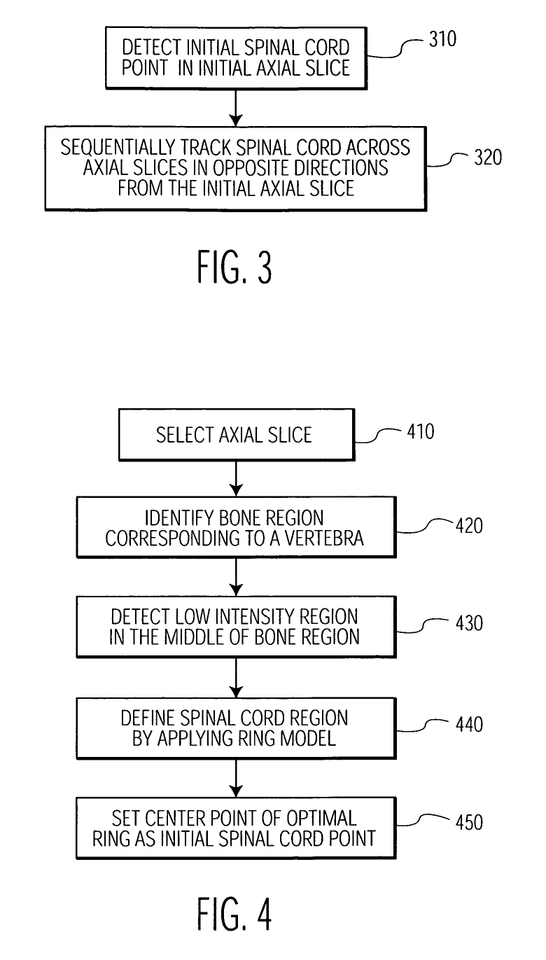

FIG. 3 is a flowchart illustrating a method of detecting the spinal cord in thoracic and abdominal CT volume data according to an embodiment of the present invention. Referring to FIG. 3, at step 310, an initial spinal cord point is detected in one of the axial slices of the CT volume data. This initial spinal cord point is an estimation of the spinal cord center in that axial slice. The axial slice used to determine the initial spinal cord point can be any of the plurality of axial slices of the CT volume data. In one embodiment, the initial axial slice is an axial slice located in the middle of the plurality of slices along the z-axis. FIG. 4 is flowchart that describes step 310 in greater detail by illustrating a method for detecting an initial spinal cord point in an axial slice according to an embodiment of the present invention.

At step 410, an axial slice is selected from the plurality of axial slices of the CT volume data. The axial slice may be selected randomly from the plurality of axial slices or a middle axial slice along the z-axis may be automatically selected. It is also possible that a user can select the axial slice using a user input device (e.g., a mouse, etc.) to input a user selection to a computer system performing this method.

At step 420, a bone region corresponding to a vertebra is identified in the axial slice. A bone region in the axial slice can be detected because bone has a high intensity in the CT volume data. Furthermore, a bone region can be determined to be a vertebrae based on a shape of the bone region and a location of the bone region in the axial slice. For example, in abdominal or thoracic CT volume data, a vertebra is typically located near the center of the axial slice. Thus, a bone region located near the center of the axial slice and shaped like a vertebrae is identified as the vertebrae.

At step 430, a low intensity region is detected in the middle of the bone region corresponding to the vertebrae. As illustrated in FIGS. 2A and 2B, the spinal cord is located in a low intensity region in the middle of the high intensity bone region that defines the vertebrae.

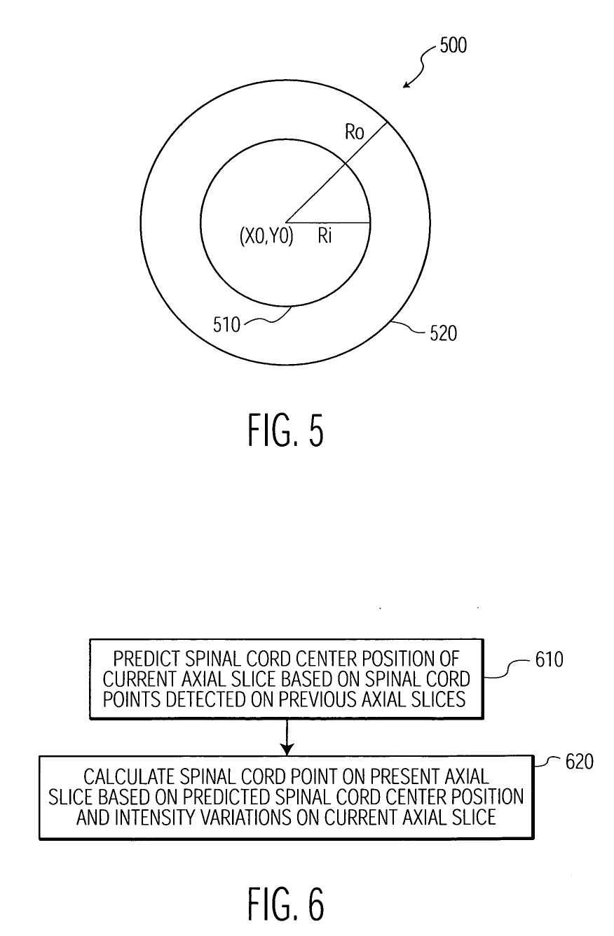

At step 440, a ring model is applied to the low intensity region to define the spinal cord region. Since the intensity of the cortical bone (vertebrae) surrounding the spinal cord is much higher than that of the spinal cord, a ring model for the spinal cord can be applied, as illustrated in FIG. 5. FIG. 5 shows a ring model 500 uniquely defined by four parameters, P={X₀, Y₀, Rₒ, Rᵢ}, where (X₀, Y₀) is the centroid of the ring, and Rₒ, Rᵢ are the radii of outer and inner circles 510 and 520, respectively. The ring model 500 defines the spinal cord region as a ring shaped region based on differences in intensities on the inner and outer circles 510 and 520 of the ring model 500. It is possible to fix Rᵢ=Rₒ−A, where A is a constant value in order to reduce the parameter set to P={X₀, Y₀, R₀}. For example, according to an embodiment of the present invention, Rᵢ=Rₒ−4. A contrast score for the ring model can be defined as the difference between average intensities in the outer and inner circles. An optimal ring P* is determined by maximizing (using an exhaustive search with box constraints) the contrast score, such that:

$${P}^{*} = {\text{arg} max}_{P ∈ ( {P}_{0} - Δ P , {P}_{0} + Δ P )} ( {\overline{I}}_{{C}_{Outer}} ( x , y ) - {\overline{I}}_{{C}_{Inner}} ( x , y ) )$$

where P₀={Xᵢₙᵢₜᵢₐₗ, Yᵢₙᵢₜᵢₐₗ, Rᵢₙᵢₜᵢₐₗ}, is an initial parameter set, ΔP={ΔX₀, ΔY₀, ΔR₀}, I̅_{C}_{_{Outer}} (x,y) and I̅_{C}_{ᵢₙₙₑᵣ} (x,y) are the average intensity on the outer and inner circles, respectively. The initial center parameters of the ring can be either automatically detected based on the fact that the spinal cord is represented by the low intensity region surrounded by the bone region, or can be selected by user input, such as a mouse click.

At step 450, center point of the optimal ring P* is set as the initial spinal cord point. The optimal ring P* is the best estimate of the location of the spinal cord using the ring model, and the center point of the optimal ring P* represents the spinal cord center for that axial slice. This center point is used as the initial spinal cord point.

Returning to FIG. 3, at step 320, the spinal cord is sequentially tracked through all of the axial slices in opposite directions along the z-axis from the initial axial slice based on the initial spinal cord point. In other words, the spinal cord is tracked from the initial spinal cord point upwards and downwards in order to determine a spinal cord point in each axial slice of the CT volume data.

One possibility is to use the position of the spinal cord point detected in the previous slice to determine the search region for the current slice. However, not all the slices contain the ring-like cortical structure, as shown in FIG. 2B. In a case in which the current slice contains an open contour, such as in FIG. 2B, the contrast score may have local maxima that are far from the spinal cord center. In addition, large shifts of the cord center may occur in some situations, especially along the y-axis. These two facts require contradictory approaches. A smaller box constraint is needed to make detection robust in slices that do not contain well a defined circular spinal canal, while bigger box constraints are needed to deal with abrupt spinal canal center shifts. The key to overcome these conflicting requirements is to integrate the previous spinal cord detection results on the spinal cord geometry. In fact, the position of spinal cord center in axial planes can be considered a random process, and the contrast scores computed at various locations on the axial slices can be considered noisy observations. Therefore, estimation theory can be applied. However, the noise model is non-Gaussian and the cord smoothness varies from subject to subject, making rigorous probabilistic formulation a difficult task. Instead, an energy based recursive robust estimation scheme can be used to sequentially detect the spinal cord point for each axial slice and thus implement step 320.

FIG. 6 is a flowchart that describes step 320 in greater detail by illustrating a method for detecting a spinal cord point in a current axial slice based on spinal cord points detected on previously processed axial slices and intensity variations of the current axial slice. This method is a recursive method performed sequentially for each of the axial slices such that a spinal cord point is detected for each axial slice.

At step 610, the position of the spinal cord center for the current axial slice is predicted based on the positions of the spinal cord points detected based on previous axial slices. Prediction of the spinal cord center can be performed by properly modeling the trajectory of the spinal cord based on the previously detected spinal cord points, for example, using an autoregressive model. Such models are optimal when based on a known system model, which is not obvious in this case. Instead, it is assumed that the spinal cord is locally linear at the current and nearby axial slices. Such an assumption corresponds to a constant speed autoregressive model. Suppose the current slice is n. K previously processed slices {n−1, . . . , n−K} are used to estimate the local direction of the spinal cord by fitting a line to corresponding spinal cord points Pₙ₋ₖ, where k ε[1 . . . K]. Line fitting is performed by minimizing an objective function:

$$E ( {L}_{n} ) = {\sum }_{k = 1}^{K} \vert D ( {p}_{n - k} , {L}_{n} ) \vert$$

where D(pₘ,L) is the distance from the spinal cord point Pₘ to the line Lₙ. The total variation norm makes the result robust despite large variations in the spinal cord position (heavy tail observation noise). Minimization of the objective function E(Lₙ) can be performed by gradient descent. Once the line Lₙ is fit by minimizing the objective function E(Lₙ), the predicted spinal cord center position {\hat{x}ₙ, ŷₙ} is calculated for the slice n, by determining the intersection of the slice n with the line Lₙ (according to constant speed autoregressive model)

At step 620, the spinal cord point for the current slice is calculated based on the predicted spinal cord center position and intensity variations in the current slice. This step calculates the spinal cord point by updating the spinal cord center position from the predicted spinal cord center position. This is implemented using a ring model to search for the spinal cord point that maximizes the contrast score (difference between the intensities of the outer and inner circles) for the ring, while also taking into account the proximity of the spinal cord point to the predicted spinal cord position. The update for the spinal cord center position can be formulated as an energy minimization problem with the predicted spinal cord center position used as an input. Given the predicted cord center position {\hat{X}ₙ,ŷₙ}, the updated position and radius can be calculated using the equation:

$$\{ {\overline{x}}_{n} , {\overline{y}}_{n} , {\overline{R}}_{n} \} = {\text{arg} min}_{{x}_{n} , {y}_{n} , {R}_{n}} - ( {\overline{I}}_{{C}_{Outer}} ( x , y ) - {\overline{I}}_{{C}_{Inner}} ( x , y ) ) + α \sqrt{{( {\hat{x}}_{n} - {x}_{n} )}^{2} + {( {\hat{y}}_{n} - {y}_{n} )}^{2}}$$

This equation minimizes an energy function which takes into account the contrast score for the ring model and the predicted spinal cord center position. The first term of the energy function represents the contrast score of the ring model. This term is negative so that the equation searches for the maximum contrast score. The second term of the energy function favors solutions that are closer to the predicted spinal cord center position. In other words, the equation attempts to maximize the contrast score while minimizing the distance between the update position and the predicted position. The balance between the two terms is controlled by the regularization parameters α. The updated position calculated using the above equation is used as the spinal cord point for the current slice.

Once the spinal cord point is detected for a current axial slice, the method is repeated for the next axial slice. This method may be repeated sequentially until a spinal cord point is detected for each axial slice of the CT volume data. However, according to an embodiment of the present invention, the method may be terminated if the maximum intensity difference (contrast score) of an axial slice is less than a threshold value. A small maximum intensity difference for an axial slice is may indicate that the axial slice is not part of the spinal column. Accordingly, when the maximum intensity difference is less than the threshold value, it is determined that the axial slice does not contain part of the spinal column, and the method is terminated.

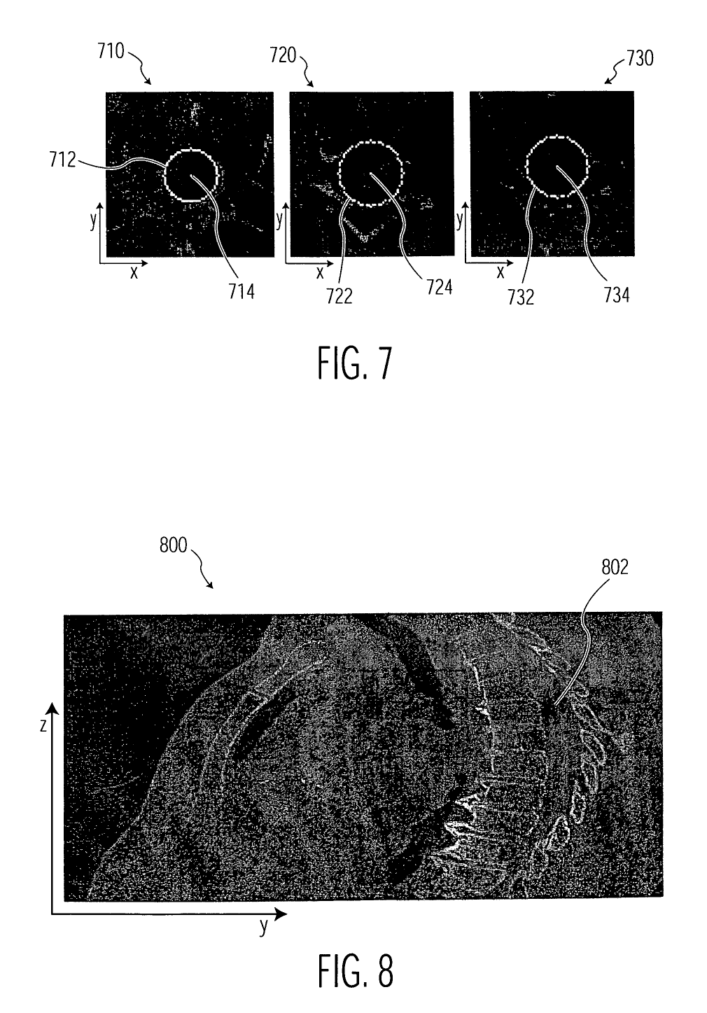

FIG. 7 shows exemplary spinal cord detection results using the above described method. As illustrated in FIG. 7, axial slices 710, 720, and 730 each have a spinal cord region 712, 722, and 732 defined using the ring model and a spinal cord point 714, 724, and 734, which is a center point of the respective spinal cord region 712, 722, and 732. As illustrated by the axial slices 720 and 730, even if an axial slice contains only parts of the ring-like cortical structure, the algorithm detects an accurate center point and radius for the ring.

When the spinal cord points for all of the axial slices are detected, these points form a centerline of the spinal cord. FIG. 8 illustrates an exemplary coronal slice 800 of a thoracic CT volume data set showing a spinal cord centerline 802 detected using the above described method. The coronal slice 800 is a view generated along the coronal plane, which is parallel to the long axis of the body (z-axis). The spinal cord centerline 802 is formed by the spinal cord points detected in each of the axial slices of the CT volume data.

The steps of the method described above have been described to give a visual understanding of the spinal cord detection method. It is to be understood, that the steps may be performed within a computer system using CT volume data stored within the computer system and representing CT images Accordingly, the steps of the above-described method can occur as internal representations within the computer system.

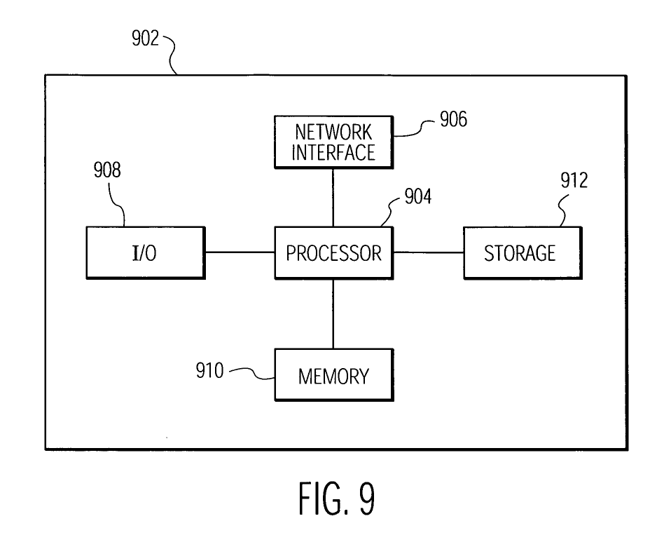

The method for detecting the spinal cord in CT volume data can be implemented on a computer using well known computer processors, memory units, storage devices, computer software, and other components. A high level block diagram of such a computer is illustrated in FIG. 9. Computer 902 contains a processor 904 which controls the overall operation of the computer 902 by executing computer program instructions which define such operation. The computer program instructions may be stored in a storage device 912 (e.g., magnetic disk) and loaded into memory 910 when execution of the computer program instructions is desired. Thus, applications to perform the steps of the above described method can be defined by the computer program instructions stored in the memory 910 and/or storage 912 and controlled by the processor 904 executing the computer program instructions. The computer 902 also includes one or more network interfaces 906 for communicating with other devices via a network. The computer 902 also includes input/output 908 which represents devices which allow for user interaction with the computer 902 (e.g., display, keyboard, mouse, speakers, buttons, etc.) One skilled in the art will recognize that an implementation of an actual computer will contain other components as well, and that FIG. 9 is a high level representation of some of the components of such a computer for illustrative purposes

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for spinal cord detection using CT volume data including a plurality of axial slices, comprising:
detecting a first spinal cord point for a first axial slice in said plurality axial slices; and
determining at least a second spinal cord point for a second axial slice in said plurality of axial slices based on the first spinal cord point.

2. The method of claim 1, wherein said step of detecting a first spinal cord point comprises:
identifying a high intensity bone region of the first axial slice corresponding to a vertebra;
detecting a low intensity region in the middle of the high intensity bone region;
defining a ring shaped spinal cord region of the first axial slice based on intensity differences between the high intensity bone region and the low intensity region using a ring model; and
setting a center point of the ring shaped spinal cord region as the first spinal cord point.

3. The method of claim 2, wherein said step of defining a ring shaped spinal cord region comprises:
defining a ring model having inner and outer circles separated by a fixed distance;
determining an optimal ring on the first axial slice at which a difference between average intensities on the outer and inner circles of the ring model is maximum.

4. The method of claim 3, wherein said step of determining an optimal ring comprises:
varying parameters defining the ring model;
determining a contrast score for a ring defined by each set of parameters of the ring model by calculating the difference between the average intensities of the outer and inner circles of that ring; and
selecting the ring having the greatest contrast score as the optimal ring.

5. The method of claim 4, wherein the parameters defining the ring model comprise a location of the center point of the ring and radii of the inner and outer circles.

6. The method of claim 1, wherein said step of determining at least a second spinal cord point comprises:
determining a spinal cord point for each of axial slice in said plurality of axial slices.

7. The method of claim 6, wherein the step of determining a spinal cord point for each of axial slice in said plurality of axial slices comprises:
tracking the spinal cord from the first spinal cord point across each of the plurality of axial slices in opposite directions from said first axial slice by sequentially detecting a spinal cord point for each axial slice in said plurality of axial slices based on at least one previously detected spinal cord point.

8. The method of claim 7, wherein said step of tracking the spinal cord comprises sequentially performing the following steps for each axial slice:
predicting a spinal cord center position on a current axial slice based on at least one previously detected spinal cord point; and
calculating the spinal cord point for the current axial slice by adjusting the predicted spinal cord center position based on intensity variations of the current axial slice and a proximity to the predicted spinal cord center position for the current axial slice.

9. The method of claim 8, wherein said step of predicting a spinal cord center position comprises:
fitting a line to K previously detected spinal cord points; and
predicting the spinal cord center position to be a point at which the line intersects the current axial slice.

10. The method of claim 9, wherein said step of fitting a line to K previously detected spinal cord points comprises:
minimizing an objective function,
$$E ( {L}_{n} ) = {\sum }_{k = 1}^{K} \vert D ( {p}_{n - k} , {L}_{n} ) \vert ,$$
where n represents the current axial slice, {n−1, . . . , n−K} represent the K previously processed slices, Lₙ represents the line, Pₘ represents a previously detected spinal cord point from an axial slice m, and D(pₘ,L) is the distance from the previously detected spinal cord pointpₘ to the line Lₙ.

11. The method of claim 8, wherein said step of calculating the spinal cord point comprises:
defining a ring shaped spinal cord region of the current axial slice using a ring model based on intensity differences on the current axial slice and a proximity of a center point of the ring shaped spinal cord region to the predicted spinal cord center position; and
setting the center point of the ring shaped spinal cord region as the spinal cord point for the current axial slice.

12. The method of claim 11, wherein the ring model has inner and outer circles separated by a fixed distance and said step of defining a ring shaped spinal cord region comprises:
calculating an optimal ring { X̅ₙ, y̅ₙ, R̅ₙ}, where X̅ₙ, y̅ₙ is the center point of the optimal ring and R̅ₙ is the radius of one of the inner and outer circles of the optimal ring, by solving the equation:
$$\{ {\overline{x}}_{n} , {\overline{y}}_{n} , {\overline{R}}_{n} \} = {\text{arg} min}_{{x}_{n} , {y}_{n} , {R}_{n}} - ( {\overline{I}}_{{C}_{Outer}} ( x , y ) - {\overline{I}}_{{C}_{Inner}} ( x , y ) ) + α \sqrt{{( {\hat{x}}_{n} - {x}_{n} )}^{2} + {( {\hat{y}}_{n} - {y}_{n} )}^{2}} ,$$
where I̅_{C}_{ₒᵤₜₑᵣ} is the average intensity on the outer circle, I̅_{C}_{ᵢₙₙₑᵣ} is the average intensities on the inner circle, {\hat{X}ₙ, ŷₙ} is the predicted spinal cord center position, and α is a regularization parameter.

13. A system for spinal cord detection in CT volume data including a plurality of axial slices, comprising:
means for detecting a first spinal cord point for a first axial slice in said plurality axial slices; and
means for determining at least a second spinal cord point for a second axial slice in said plurality of axial slices based on the first spinal cord point.

14. The system of claim 13, wherein said means for detecting a first spinal cord point comprises:
means for identifying a high intensity bone region of the first axial slice corresponding to a vertebra and a low intensity region in the middle of the high intensity bone region;
means for defining a ring shaped spinal cord region of the first axial slice based on intensity differences between the high intensity bone region and the low intensity region using a ring model; and
means for setting a center point of the ring shaped spinal cord region as the first spinal cord point.

15. The system of claim 14, wherein the ring model comprises inner and outer circles separated by a fixed distance said means for defining a ring shaped spinal cord region comprises:
means for determining an optimal ring on the first axial slice at which a difference between average intensities on the outer and inner circles of the ring model is maximum.

16. The system of claim 13, wherein said means for determining at least a second spinal cord point comprises:
means for tracking the spinal cord from the first spinal cord point across each of the plurality of axial slices in opposite directions from said first axial slice by sequentially detecting a spinal cord point for each axial slice in said plurality of axial slices based on at least one previously detected spinal cord point.

17. The system of claim 16, wherein said means for tracking the spinal cord comprises:
means for predicting a spinal cord center position for each axial slice based on at least one previously detected spinal cord point; and
means for calculating the spinal cord point for each axial slice by adjusting the predicted spinal cord center position based on intensity variations of that axial slice and a proximity to the predicted spinal cord center position for that axial slice.

18. The system of claim 16, wherein said means for predicting a spinal cord center position comprises:
means for fitting a line to K previously detected spinal cord points; and
means for predicting the spinal cord center position to be a point at which the line intersects the axial slice.

19. The system of claim 16, wherein said means for calculating the spinal cord point comprises:
means for defining a ring shaped spinal cord region of the axial slice using a ring model based on intensity differences on the axial slice and a proximity of a center point of the ring shaped spinal cord region to the predicted spinal cord center position; and
means for setting the center point of the ring shaped spinal cord region as the spinal cord point for the axial slice.

20. A computer readable medium storing computer program instructions for performing a method for spinal cord detection in CT volume data including a plurality of axial slices, said computer program instructions defining the steps comprising:
detecting a first spinal cord point for a first axial slice in said plurality axial slices; and
determining at least a second spinal cord point for a second axial slice in said plurality of axial slices based on the first spinal cord point.

21. The computer readable medium of claim 20, wherein the computer program instructions defining the step of detecting a first spinal cord point comprise computer program instructions defining the steps of:
identifying a high intensity bone region of the first axial slice corresponding to a vertebra;
detecting a low intensity region in the middle of the high intensity bone region;
defining a ring shaped spinal cord region of the first axial slice based on intensity differences between the high intensity bone region and the low intensity region using a ring model; and
setting a center point of the ring shaped spinal cord region as the first spinal cord point.

22. The computer readable medium of claim 21, wherein the computer program instructions defining the step of defining a ring shaped spinal cord region comprise computer program instructions defining the steps of:
defining a ring model having inner and outer circles separated by a fixed distance,
determining an optimal ring on the first axial slice at which a difference between average intensities on the outer and inner circles of the ring model is maximum.

23. The computer readable medium of claim 22, wherein the computer program instructions defining the step of determining an optimal ring comprise computer program instructions defining the steps of:
varying parameters defining the ring model;
determining a contrast score for a ring defined by each set of parameters of the ring model by calculating the difference between the average intensities of the outer and inner circles of that ring; and
selecting the ring having the greatest contrast score as the optimal ring.

24. The computer readable medium of claim 20, wherein the computer program instructions defining the step of determining at least a second spinal cord point comprise computer program instructions defining the step of:
determining a spinal cord point for each of axial slice in said plurality of axial slices.

25. The computer readable medium of claim 24, wherein the computer program instructions defining the step of determining a spinal cord point for each of axial slice in said plurality of axial slices comprise computer program instructions defining the step of:
tracking the spinal cord from the first spinal cord point across each of the plurality of axial slices in opposite directions from said first axial slice by sequentially detecting a spinal cord point for each axial slice in said plurality of axial slices based on at least one previously detected spinal cord point.

26. The computer readable medium of claim 18, wherein the computer program instructions defining the step of tracking the spinal cord comprise computer program instructions defining the following steps for each axial slice:
predicting a spinal cord center position on a current axial slice based on at least one previously detected spinal cord point; and
calculating the spinal cord point for the current axial slice by adjusting the predicted spinal cord center position based on intensity variations of the current axial slice and a proximity to the predicted spinal cord center position for the current axial slice.

27. The computer readable medium of claim 26, wherein the computer program instructions defining the step of predicting a spinal cord center position comprise computer program instructions defining the steps of:
fitting a line to K previously detected spinal cord points for K previously processed axial slices; and
predicting the spinal cord center position to be a point at which the line intersects the current axial slice.

28. The computer readable medium of claim 27, wherein the computer program instructions defining the step of fitting a line to K previously detected spinal cord points comprise computer program instructions defining the step of:
minimizing an objective function,
$$E ( {L}_{n} ) = {\sum }_{k = 1}^{K} \vert D ( {p}_{n - k} , {L}_{n} ) \vert ,$$
where n represents the current axial slice, {n−1, . . . , n−K} represent the K previously processed slices, Lₙ represents the line, Pₘ represents a previously detected spinal cord point from an axial slice m, and D(pₘ,L) is the distance from the previously detected spinal cord pointpₘ to the line Lₙ.

29. The computer readable medium of claim 26, wherein the computer program instructions defining the step of calculating the spinal cord point comprise computer program instructions defining the steps of:
defining a ring shaped spinal cord region of the current axial slice using a ring model based on intensity differences on the current axial slice and a proximity of a center point of the ring shaped spinal cord region to the predicted spinal cord center position; and
setting the center point of the ring shaped spinal cord region as the spinal cord point for the current axial slice.

30. The computer readable medium of claim 26, wherein the ring model has inner and outer circles separated by a fixed distance and the computer program instructions defining the step of defining a ring shaped spinal cord region comprise computer program instructions defining the step of:
calculating an optimal ring { X̅ₙ, y̅ₙ, R̅ₙ}, where X̅ₙ, y̅ₙ is the center point of the optimal ring and R̅ₙ is the radius of one of the inner and outer circles of the optimal ring, by solving the equation:
$$\{ {\overline{x}}_{n} , {\overline{y}}_{n} , {\overline{R}}_{n} \} = {\text{arg} min}_{{x}_{n} , {y}_{n} , {R}_{n}} - ( {\overline{I}}_{{C}_{Outer}} ( x , y ) - {\overline{I}}_{{C}_{Inner}} ( x , y ) ) + α \sqrt{{( {\hat{x}}_{n} - {x}_{n} )}^{2} + {( {\hat{y}}_{n} - {y}_{n} )}^{2}} ,$$
where I̅_{C}_{ₒᵤₜₑᵣ} is the average intensity on the outer circle, I̅_{C}_{ᵢₙₙₑᵣ} is the average intensities on the inner circle, {\hat{X}ₙ, ŷₙ} is the predicted spinal cord center position, and α is a regularization parameter.
